(19) United States
(12) Patent Application Publication
(10) Pub. No.: US 2020/0226677 A1
(43) Pub. Date: Jul. 16, 2020

(54) SYNDICATED LOAN DISTRIBUTED LEDGER PASS-THROUGH PROCESSING

(71) Applicant: Bank of America Corporation, Charlotte, NC (US)

(72) Inventors: Lalit Dhawan, Franklin Park, NJ (US); Ron Papka, Short Hills, NJ (US); Brandon Castagna, Charlotte, NC (US)

(21) Appl. No.: 16/378,700

(22) Filed: Apr. 9, 2019

Related U.S. Application Data
(60) Provisional application No. 62/791,092, filed on Jan. 11, 2019.

(51) Int. Cl. G06Q 40/02; G06Q 20/10; G06Q 20/06; G06Q 20/40; H04L 9/06

(52) U.S. Cl. CPC G06Q 40/025; G06Q 20/102; H04L 9/0637; G06Q 20/405; G06Q 20/0658

(57) ABSTRACT

Apparatus and methods for utilizing distributed electronic ledger technology to process and record syndicated loan payments are provided. An agent address may receive an interest payment from a borrower address (e.g., interest accrual). The agent address may distribute the interest, pro rata, to members of a lender consortium and records the payments on the distributed electronic ledger. The distributed electronic ledger may provide and maintain a shared source of truth for event details associated with a syndicated loan. Facility agreements and corresponding utilizations (e.g., loans) may be represented on the distributed electronic ledger as smart contracts. As events occur, a corresponding record of each event is anchored to the facility/utilization smart contract, creating a chronological audit trail of all activity associated with the syndicated loan.

### CROSS REFERENCE TO RELATED APPLICATION

This application is a nonprovisional of U.S. Provisional Application No. 62/791,092, filed on Jan. 11, 2019, which is hereby incorporated by reference herein in its entirety.

### FIELD OF TECHNOLOGY

This application describes apparatus and methods for pass-through processing of syndicated loans using smart contracts running on a distributed electronic ledger.

### BACKGROUND

Typically day-to-day processing of a syndicated loan is handled by an agent. The agent may act in a representative capacity on behalf of members of a lending consortium. The members of the lending consortium may pool their financial resources to fund a syndicated loan for a borrower.

The agent is typically responsible for disbursing funds to the borrower. The agent is also typically responsible for accepting loan payments from the borrower. The agent may distribute proceeds of the syndicated loan to members of the lending consortium.

Because of the many parties involved in syndicated loan processing, such processing is expensive. For example, multiple currency transfers among the many parties may quickly accrue significant wire transfer fees. Furthermore, each of the multiple currency transfers may be associated with different payment settlement times. Such delays and incongruities may prevent parties timely reconciling their balances.

Further complicating matters is that a payment transfer is typically transmitted independently of notices describing the payment transfer. Notices may not arrive at the same time as a payment. A notice may not arrive at all. The absence of timely, reliable notification adds costs and injects error into typical syndicated loan processing.

It would be desirable to provide apparatus and methods for overcoming technical challenges that have caused increased costs, time delays and wasted resources associated with typical syndicated loan processing.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative prior-art syndicated loan processing scenario;

FIG. 2 shows an illustrative syndicated loan processing scenario in accordance with principles of the disclosure;

FIG. 3 shows an illustrative syndicated loan processing scenario in accordance with principles of the disclosure;

FIG. 4 shows an illustrative syndicated loan processing scenario in accordance with principles of the disclosure;

FIG. 5 shows an illustrative syndicated loan processing scenario in accordance with principles of the disclosure; and

FIG. 6 shows an illustrative syndicated loan processing scenario in accordance with principles of the disclosure;

FIG. 7 shows an illustrative process in accordance with principles of the disclosure; and

FIG. 8 shows an illustrative process in accordance with principles of the disclosure.

### DETAILED DESCRIPTION

Apparatus and methods for pass-through processing of a syndicated loan are provided.

Pass-through processing may convey loan payment notice details as a part of a payment instruction. The syndicated loan may be codified on a distributed electronic ledger. A distributed electronic ledger may store records in any suitable format. For example, records may be stored sequentially as they are generated, one after the other in a continuous ledger. Records may be stored in blocks, such as in a blockchain.

Records stored in a distributed electronic ledger may only be added to the ledger when the participants responsible for maintaining the distributed ledger reach a consensus. The distributed ledger may use any suitable consensus algorithm such as Proof of Work, Proof of Stake or Practical Byzantine Fault Tolerance.

The distributed ledger may be a public or unpermissioned distributed ledger. A public distributed ledger does not have restriction on who may participate in the establishing a consensus for adding a new record.

The distributed ledger may be a private or permissioned distributed. A private distributed ledger has restrictions on who may participate in the establishing a consensus for adding a new record.

The distributed ledger may utilize a combination of private and public participation in establishing a consensus. For example, the distributed ledger may require a threshold number of private and/or public votes before recording a transaction on the distributed ledger. Utilization of private entities may allow for achieving a consensus (or rejection) of a transaction faster than wholly public distributed ledgers.

The distributed ledger may be a blockchain. Records stored in a blockchain are organized in blocks. Each block may include multiple records. The blocks are linked to one another and secured using cryptography.

A distributed ledger may link details of the syndicated loan from an external repository. The distributed ledger may link different parties that participate in the syndicated loan.

Apparatus and methods may provide tokenization of ownership interest in the syndicated loan across the members of a lending consortium. For example, ownership interests in a syndicated loan may be represented by crypto credits. Crypto credits may be distributed among members of a lending consortium. An amount and/or value of crypto credits held by a member may correspond to the member's pro rata ownership share in a syndicated loan.

Crypto credits used to represent ownership shares in a syndicated loan may be a bookkeeping technique for tracking who is liable for providing funds to a borrower and who is entitled to amount of proceeds of a syndicated loan. However, even such crypto credits may be marketable and may be bought/sold on the open market.

A member's pro rata ownership share in the syndicated loan may obligate the member to contribute value (e.g., cash, assets or other financial resources) that may be lent to a borrower. A member's pro rata ownership share in the syndicated loan may entitle the member to a pro rata share of proceeds (e.g., interest payments, fees) paid by the borrower. Members of the lending consortium may change their pro rata ownership share by transferring their crypto credits. For example, a member may transfer crypto credits to another member of the lending consortium. Transferring crypto credits may allow ownership changes to settle in seconds instead of days. Transferring crypto credits may provide a way for changes in ownership to be immutably recorded.

A crypto credit may represent government-issued currency such as US Dollars, Euros or Japanese Yen. Crypto credits may be cryptocurrency such as Bitcoin, Ethereum, Ripple, Bitcoin Cash, NEM, Litecoin, IOTA, NEO, Dash, Qtum, Monero and/or Dogecoin. As used herein, cryptocurrency or government-issued currency may be referred to as “fiat currency.” A crypto credit may be a tokenized representation of an arbitrary value. For example, crypto credits may be crypto tokens created specifically to represent an ownership interest in a syndicated loan.

A crypto credit may be convertible into fiat currency. A crypto credit may be convertible from one cryptocurrency into another cryptocurrency. Crypto credits may be convertible into physical cash. Crypto credits may be convertible into government-issued currency. A crypto credit may or may not be tradeable on public exchanges or forums.

Apparatus and methods may move crypto credits in and out of a distributed ledger. For example, crypto credits may be moved in and out of a blockchain for purpose of facilitating real-time instant credit/debit transfers between parties.

Apparatus and methods may provide mechanisms for bridging transfers of crypto credits and conventional fiat currency payment delivery schemes. Apparatus and methods may provide for exchange of crypto credits for the purpose of making or receiving syndicated loan payments. Apparatus and methods may identify crypto credits and values associated with or represented by those crypto credits for the purpose of bridging between boundaries of financial institutions participating in a syndicated loan.

Apparatus and methods may utilize smart contracts for collecting and processing principal and interest payments. Smart contract may be run on computer systems that record transactions on a distributed electronic ledger. Smart contracts may execute transfers of crypto credits. Transfers of crypto credits may reduce wire transfer fees and payment settlement times for parties to the syndicated loan.

Apparatus and methods may provide a platform for tokenizing syndicated loans and trading crypto credits representing the syndicated loans on secondary markets. Such trading may increase liquidity across a financial ecosystem.

Apparatus and methods may allow transactions associated with the syndicated loan to be anchored to a shared, verifiable source of truth (e.g., a blockchain). Apparatus and methods may provide increased transparency to reduce breakage and subsequent reconciliation activities associated with interest and principal payments of a syndicated loan.

Systems may include a distributed ledger. The distributed ledger may include a blockchain of electronic data records. Each record may be authenticated by a consensus protocol. A complete copy of the blockchain may be stored on multiple computer systems. Each computer system that stores a copy of the blockchain may be a “node.”

Groups of authenticated transactions may be gathered into “blocks.” A node may add a “block” to the blockchain. Each block may include data and metadata. Metadata may include a reference to the previous block in the chain and a unique identifier associated with the previous block. The unique identifier may be an output of a hash function.

The system may include a smart contract. A smart contract may include machine executable instructions running on a computing system. The executable instructions may be self-executing and trigger actions at specified times and/or based on reference to the occurrence or non-occurrence of a target action or event. Some or all of the computer executable instructions may be embodied in hardware or firmware components of a computing system.

A smart contract may be run in cloud computing and virtualization implementations of software. Such implementations may be designed to run on a physical apparatus supplied externally by a hosting provider, a client, or other virtualized platform. A smart contract may include computer executable instructions for invoking user functionality related to communication, such as email, short message service (“SMS”), and voice input and speech recognition applications.

Smart contracts may utilize computer-executable instructions, such as program modules, executed by a processor on the computing system. Generally, program modules include routines, programs, objects, components, data structures, etc. that perform particular tasks or implement particular abstract data types. Smart contracts may be operational with distributed computing environments where tasks are performed by remote processing devices that are linked through a communications network. In a distributed computing environment, program modules may be located in both local and remote computer storage media including memory storage devices. Smart contracts may rely on a network of remote servers hosted on the Internet to store, manage, and process data (e.g., “cloud computing” and/or “fog computing”). For example, smart contracts may be run on nodes that form a blockchain environment.

A smart contract may include a lender smart contract. The lender smart contract may be run on the distributed ledger. The lender smart contract may be configured to control interaction among members of a lending consortium. The lending consortium may include any suitable number of members. A lending consortium may be formed to provide a syndicated loan to a borrower. Members of the lending consortium may pool their financial resources to provide disbursements to the borrower. Each member of the lending consortium may contribute financial resources and take on risk associated with the syndicated loan. The lender smart contract may be configured to provide automated control of interactions between members of the lending consortium.

Systems may include a borrower smart contract. The borrower smart contract may run on the distributed ledger. The borrower smart contract may be configured to provide automated control of interactions between the lending consortium and the borrower. The borrower smart contract may replace the agent in conventional syndicated loan processing.

The borrower smart contract may be configured to receive a borrower payment on the syndicated loan. The borrower smart contract may be configured to validate the borrower payment. The borrower payment may be validated using the consensus protocol of the c. The borrower smart contract may record the borrower payment within a block on a blockchain.

The lender smart contract may be configured to receive confirmation that the borrower payment has been validated and recorded on the distributed ledger. Based on the recorded borrower payment, the lender smart contract may be configured to distribute crypto credits among the members of the lending consortium. Each member of the lending consortium may receive crypto credits proportionally corresponding to financial resources, advanced by the member, to the lending consortium or directly to the borrower. Crypto credits may be distributed proportional to a member's ownership interest in the syndicated loan.

In some embodiments, a first class of crypto credits may represent a member's ownership interest in the syndicated loan. A second class of crypto credits may represent a payments made or received from a borrowed, member or other entity associated with the syndicated loan. Apparatus and methods described herein may utilize the first class of crypto credits, the second class of crypto credits or a combination of the first and second classes of crypto credits.

The borrower smart contract may be configured to validate a transfer of crypto credits from the borrower to the lending consortium. The transfer from the borrower to the lending consortium may be a loan payment made by the borrower. The borrower smart contract may be configured to validate a transfer of crypto credits from the lending consortium to the borrower. The transfer from the lending consortium to the borrower may be a disbursement of funds to the borrower. A transfer of crypto credits may be validated using the consensus protocol of the blockchain. A validated transfer of crypto credits may be recorded in one or more blocks of a blockchain.

The borrower smart contract may be configured to generate notice data for actions associated with the syndicated loan. For example, the notice data may include detail on a loan payment made by the borrower. The notice data may be generated based on a transfer of crypto credits. The notice data may be generated based on a validated transfer.

Notice data may include a date/time of a crypto credit transfer, an identifier associated with the borrower, an identifier of the lending consortium and an amount of the payment. The payment amount may be in fiat currency. The payment amount may be in crypto credits. The system may record a transfer and the loan payment notice as part of a single transaction in the distributed ledger.

In response to receiving confirmation that a borrower payment has been validated and recorded on the distributed ledger, the lender smart contract may be configured to calculate a distribution of proceeds for each member of the lending consortium. For example, the borrower payment may include loan principal and loan interest. Each member of the lending consortium may be entitled to a proportional share of the principal and interest.

Notice data may include a lender notice. The system may generate a lender notice for each member of the lending consortium. The lender notice may include an explanation of the payment transferred to the member. The lending notice may inform the member of a total amount paid by the borrower. The lending notice may inform the member of a proportional share of the borrower's payment they are entitled to. The lending notice may inform the member of interest or other fees paid by the borrower. The lending notice may inform the member of a proportional share of the fees they are entitled to.

Using the distributed ledger, the notice and payment transfer may be recorded as a single transaction. Recording the notice and payment as a single transaction may ensure a record of the notice is not separable from a record of the payment. Single transaction recordation of notice and payments may reduce breakage delays and costs associated with conventional syndicated loan processing. Recording the notice and the payment as a single transaction may ensure that notice is provided at the same time as when the transaction/payment occurs.

The lender smart contract may further be configured to determine a distribution of crypto credits for each member of the lending consortium. The distribution of crypto credits may be determined based on the borrower and/or lender payments. The lender smart contact may trigger conversion of distributed crypto credits into fiat currency.

A distribution of crypto credits to a member of the lending consortium may be determined based on a current exchange rate associated with converting crypto credits into a desired fiat currency. In some embodiments, the lender smart contract may redistribute crypto credits among members of the lending consortium based on a reference fiat currency associated with the syndicated loan, fiat currency desired by a member or any other suitable basis.

A lender notice and a lender payment may form a lender-member transaction. The lender smart contract may be configured to record each lender-member transaction as a single transaction in the distributed ledger.

Members of a lending consortium may wish to change their financial positions with respect to the syndicated loan. Changing a financial position make include a change in a members ownership interest in the syndicated loan. For example, a member may wish to exit the lending consortium. A member may wish to assume greater responsibility for providing funds to the borrower. A member may wish to assume less responsibility for advancing funds to the borrower. A new member may wish to join the lending consortium. The lender smart contract may be configured to process these changes.

Conventionally, such changes may take days to settle. In addition to settling financial obligations, such changes typically require coordinating contractual obligations between parties. Coordinating contractual obligations is typically a human intensive process. Approvals are needed and documents needed to be prepared and signed. After documents were signed by one party, documents need to be circulated to the other party for counter signature. After documents were signed by the parties, currency transfers and associated notices needed to be processed. Currency transfers may then need to be reconciled. Using conventionally processes typically requires about 6-days to complete a change in pro rata ownership of a syndicated loan.

Systems described herein may reduce the time delay to seconds instead of days. For example, a lender smart contract may be configured to receive a first request from a first member of the lending consortium. The first member may request a reduction in their pro rata obligation to advance funds to the borrower. The lender smart contract may validate the first request. Validating the first request may be performed by following the consensus protocol associated with the distributed ledger. Validating the first request may include determining that the first request was signed using a private cryptographic key of the first member.

The lender smart contract may be configured to record the first request in the distributed ledger. After recording the first request, the lender smart contract may circulate a second request for a second member of the lending consortium. The second request may ask the second member to increase their pro rata obligation to advance funds to the borrower. The second member may assume obligations of the first member.

The lender smart contract may validate a response received from the second member. Validating the response may be performed by following the consensus protocol associated with the distributed ledger. Validating the response may include determining that the response was signed using a private cryptographic key of the second member. The lending smart contact may record the response of the second member in the distributed ledger.

Recordation of the response of the second member in the distributed ledger by the lender smart contract may serve as a trigger event for the borrower smart contract. For example, in response to recordation of the response of the second member, the borrower smart contract may be configured to record a transaction between the lending consortium and the borrower. The transaction may correspond to borrower approval of the revised obligations of the first and second members of the lending consortium.

In some embodiments, the lender smart contract may be configured to obtain approval from the borrower smart contract before recording the response of the second member in the distributed ledger. In some embodiments, the lender smart contract may be configured to obtain approval from the borrower smart contract before validating and/or recording the first request to change obligations of the first member. In some embodiments, the lender smart contract may be configured to obtain approval from the borrower smart contract before validating and/or recording the second request for another member of the lending consortium to assume obligations of the first member. In some embodiments, the borrower smart contract may be configured to obtain approval from the lender smart contract before validating and/or recording a transaction that adjusts pro rata obligations of lending consortium members in the distributed ledger.

An approval may be a message transmitted by a smart contract. An approval may be a message signed using a private cryptographic key controlled by a smart contact.

The lender smart contract may be configured to utilize a first private cryptographic key. The lender smart contract may use the first private cryptographic key to sign transactions executed by the lending consortium. For example, the lender smart contact may advance funds to the borrower. The transaction advancing the funds may be signed, on behalf of the lending consortium, using the first private cryptographic key. The first private cryptographic key may be controlled by the lender smart contract.

The lender smart contract may also use a first public cryptographic key. The first public cryptographic key may be used to validate transactions executed between members of the lending consortium. For example, a request to change obligations of a first member may be signed using a private cryptographic key of the first member. The lender smart contract may validate the first member's request using the first public cryptographic key.

The borrower smart contract may be configured to utilize a first public cryptographic key. The borrower smart contract may use the first public cryptographic key to validate transactions executed by the lending consortium. The borrower smart contract may also utilize a second public cryptographic key. The second public cryptographic key may be used by the borrower smart contract to validate transactions executed by a member of the lending consortium. For example, any change in obligations of a specific member of the lending consortium may require borrower approval. The borrower smart contract may provide such approval after validating that a change request was signed by a member of the lending consortium.

The borrower smart contact may also utilize a second private cryptographic key. The borrower smart contact may use the second private cryptographic key to sign transaction on behalf of the borrower. For example, the borrower smart contract may use the second private cryptographic key to sign payments made by the borrower to the lending consortium. The borrower smart contract may use the second private cryptographic key to countersign disbursements received from the lending consortium.

Apparatus and methods may include a subrogation smart contract. The subrogation smart contract may control interaction between a member of the lending consortium and a third party not in privity with any other party to the syndicated loan.

For example, a member of the lending consortium may desire to subrogate its obligations to provide funds to the borrower without obtaining borrower approval. The member may remain obligated for its full financial commitment to the borrower or lending consortium and may subcontract its obligations the syndicated loan to a third-party lender. Under such an arrangement, there will not be any change vis-a-vis the lending consortium because the member remains obligated for it full financial responsibility. However, the lending member may have an agreement with the third-party lender to provide funds should the lending member be requested to provide funds to the borrower under the lending member's obligations to the lending consortium.

A subrogation smart contract may manage the arrangement between an individual lending member and one or more third-party lenders. Triggers for the subrogation smart contract may include performance of the borrower, agent or other lender members, as documented and recorded on the distributed ledger. For example, borrower payments or agent disbursements may trigger transactions between the lender member and a third-party lender. Such a subrogation arrangement may not require borrower approval under terms of the syndicated loan.

Systems for pass-through processing of a syndicated loan are provided. Systems may include a syndicated smart contract. The syndicated smart contract may run on one or more computer systems. The one or more computer systems may be one or more nodes of a distributed electronic ledger.

The syndicated smart contract may be configured to control crypto credit transfers. The syndicated smart contract may control crypto credit transfers between an agent address and a borrower address. The syndicated smart contract may control crypto credit transfers between an agent address and a lending member address. The syndicated smart contract may control crypto credit transfers between the agent address and one or more of a plurality of lending member addresses.

Systems may include a crypto credit exchange. The crypto credit exchange may operate a protocol designed to provide transfers of fiat currency and/or crypto credits between parties. Such transfers may be implemented using a distributed ledger. Using the distributed ledger, such transactions may occur and settle faster than conventional transaction methods. The crypto credit exchange may operate a protocol designed to provide fast conversions of crypto credits into fiat currencies. Fast transactions may refer to transactions that occur in less than one minute. A crypto credit exchange may be configured to receive and execute transfer instructions generated by a smart contract such as a syndicated smart contract.

A crypto credit exchange may utilize conventional currency transfer systems. For example, a crypto credit exchange may utilize the FedWire system to transfer US Dollars. A crypto credit exchange may utilize the SWIFT (Society for Worldwide Interbank Financial Telecommunication) network to transfer foreign currencies.

The syndicated smart contract may be configured to initiate and validate crypto credit transfer requests. For example, a message sent from an agent address may trigger the syndicated smart contract to initiate a transfer to a borrower address. The transfer to the borrower address may provide a borrower disbursement associated with a syndicated loan.

The syndicated smart contract may be configured to initiate and validate crypto credit transfer requests received from a borrower address. For example, a message sent from the borrower address may trigger the syndicated smart contract to initiate a transfer of crypto credits to an agent address. The transfer of crypto credits to the agent address may provide a borrower payment associated with a syndicated loan.

The syndicated smart contract may be configured to issue executable instructions to the crypto credit exchange. The executable instructions may transfer crypto credits between the agent address and the borrower address. The executable instructions may transfer crypto credits between the agent address and one or more of the plurality of lending member addresses. A transfer between the agent address and one or more of the plurality of lending member addresses may correspond to a distribution, among members of a lending consortium, of proceeds associated with a payment made by the borrower.

The syndicated smart contract may be configured to generate executable instructions that transfer crypto credits from the agent address to the borrower address. The syndicated smart contract may be configured to settle a transaction. A transaction may be settled by converting transferred crypto credits into a desired fiat currency. The desired fiat currency may be specified in the syndicated smart contract. Based on the transfer and associated conversion, the syndicated smart contract may generate notice data.

Settling a transaction between two parties may include a transfer of crypto credits and/or fiat currency to a third party. The syndicated smart contract may be configured to control any suitable settlements and associated transactions.

The syndicated smart contract may be configured to record transfers, executable instructions and/or notice data in the distributed ledger. The syndicated smart contract may be configured to record transfer of fiat currency using conventional methods in the distributed ledger.

For example, settling a transaction may include a transfer of US Dollars using FedWire. Transaction identifiers and messages associated with the FedWire transaction may be recorded in a blockchain. Information recorded in the blockchain may be immutable and difficult to change. Such an immutable ledger may provide a reliable source of truth for tracking transfers of value and information between parties to a syndicated loan.

The syndicated smart contract may be further configured to formulate an adjustment transaction. An adjustment transaction may transfer or redistribute crypto credits from a first lending member (or corresponding address) to a second lending member (or corresponding address). For example, a first member of the lending consortium may wish to assume greater responsibility for providing disbursements to the borrower. The greater responsibility may be represented by the first member of the lending consortium holding a larger number of crypto credits than other members or increasing its prior holdings of crypto credits representing loan ownership. Assuming greater responsibility may include increasing a pro rata ownership interest in a syndicated loan.

Crypto credits may be distributed among members of a lending consortium. Crypto credits may be distributed among members of a lending consortium based a value of assets contributed by each member to the lending consortium. Each crypto credit may represent a measure of ownership in a syndicated loan. Each crypto credit may represent a value a particular member of the lending consortium is responsible for providing to the borrower. Each crypto credit may represent a value a particular member of the lending consortium in entitled to when the borrower makes payments on the syndicated loan.

The value or number of crypto credits held by a member of the lending consortium may correspond to a value of funds the member is contractually obligated to provide to the borrower. The value or number of crypto credits held by a member of the lending consortium may also correspond to a value of proceeds of the syndicated loan that is contractually owed to the member.

Members of the lending consortium may shift and change their levels of ownership (e.g., responsibility to provide funds to the borrower and corresponding rights to proceeds) by redistributing the value/amount of crypto credits they each hold. A quantity of crypto credits held by each member of the lending consortium may be recorded in the distributed ledger. Transactions transferring crypto credits between members of the lending consortium may be recorded in the distributed ledger.

Distributions, or redistributions, of crypto credits to members of the lending consortium may be subject to approval by the borrower. Transfers of crypto credits among members of the lending consortium may also be subject to approval of the borrower. Approval or disapproval of the borrower may also be recorded in the distributed ledger. Smart contracts may control issuance or denial of an approval.

When the borrower approves a transaction, the syndicated smart contract may issue executable instructions to a crypto exchange. The executable instructions may transfer crypto credits from a first lending member addresses to a second lending member addresses. The executable instructions may be recorded in the distributed ledger.

The executable instructions may be executed by a platform running on a first distributed ledger. The executable instructions executed by the first distributed ledger may be recorded in a second distributed ledger. The first distributed ledger may be a first blockchain. The second distributed ledger may be a second blockchain.

The syndicated smart contract may be configured to receive a disbursement request from the borrower address. The disbursement request may include an amount of a desired fiat currency. The syndicated smart contract may determine a proportional amount of crypto credits required from each lending member address to provide the desired amount of fiat currency to the borrower.

The syndicated smart contract may formulate instructions executable by the crypto exchange. The executable instructions may transfer the proportional amount of crypto credits from each lending member address to the agent address. In some embodiments, the executable instructions may transfer the proportional amount of crypto credits from each lending member address directly to the borrower address.

In some embodiments, following, or simultaneously with a transfer of crypto credits, a settlements transaction may be initiated. The settlement transaction may transfer a desired amount of fiat currency to the borrower. The desired amount of fiat currency may be determined based on the crypto credit transfer. The desired amount of fiat currency may be delivered to a target bank account of the borrower. The desired amount of fiat currency may be transferred to the borrower from a target bank account of the agent or member(s) of the lending consortium. The syndicated smart contract may formulate executable instructions that, when run on the crypto exchange, effectively transfer the desired amount of fiat currency to the borrower.

Each transfer of crypto credits may be recorded in the distributed ledger along with notice data. The notice data may explain why a particular amount of crypto credits were transferred. Notice data may cross-reference other transactions or information recorded in the distributed ledger. A transfer of crypto credits may take place using a first distributed ledger and the recordation of the executable instructions and notice data may be recorded in a second distributed ledger.

Each conversion of crypto credits to fiat currency may be recorded in a distributed ledger along with notice data. Notice data may explain why the conversion of the specified of crypto credits occurred. Notice data may explain an event that triggered the syndicated smart contract to initiate the transfer/conversion of crypto credits.

The syndicated smart contract may be configured to determine an amount of crypto credits distributed to each member of a lending consortium. The syndicated smart contract may be triggered to calculate the distribution in response to title of an asset being transferred to the agent address. For example, a member of the lending consortium may provide non-cash assets to meet its proportional obligations to supply funds to the borrower. The member may transfer title of the asset to an agent address. The agent address may hold title to assets associated with one or more members of the lending consortium.

When the agent address receives title to an asset, the syndicated smart contract may trigger a distribution of crypto credits to the member that transferred the title. The amount of crypto credits distributed to the member may correspond to a value of the asset whose tile is held by the agent address. Valuation of the assets may be performed by a third party entity or address. Such a third party entity may be referred to as an “oracle.”

For example, if a member transfers foreign currency to the agent address, a value of the foreign currency may be determined based on the day's foreign currency exchange rate, as published by a specified exchange. For example, if the member transfers title to real estate, the value of the real estate may be determined based on a valuation provided by an assessment agency. The assessment may be recorded in the distributed ledger. The syndicated smart contract may distribute a value of crypto credits corresponding to the valuation recorded on the distributed ledger. Recording a valuation on a distributed ledger may be trigger event for a smart contract.

Methods for pass-through processing of a syndicated loan are provided. Methods may include recording the syndicated loan on a distributed electronic ledger. Methods may include receiving a payment transaction from a borrower. The payment transaction may correspond to a loan payment from the borrower to a lending consortium that extended the syndicated loan to the borrower.

Methods may include validating the payment transaction. Validating the payment transaction may include following a consensus protocol associated with recording transactions on the distributed ledger.

Methods may include recording the payment transaction on a blockchain. In response to recording the payment transaction, methods may include validating a distribution to members of a lending consortium. Each member of the lending consortium may be entitled to a proportional amount of the borrower payment. A distribution to the members may be in the form of crypto credits.

The distribution may include a conversion to or, settlement in, a desired fiat currency. The conversion may occur automatically, without requiring intervention by the transferor or transferee. A distribution may be controlled by one or more smart contracts. The one or more smart contracts may run on the blockchain or other distributed ledger. The one or more smart contracts may trigger conversion of distributed crypto credits into a desired fiat currency within a pre-determined timeframe. The timeframe may be 1 second, 5 seconds, seconds, 1 minute, 10 minutes, 1 hour or any suitable timeframe.

Methods may include recording a crypto credit distribution on the distributed ledger. Methods may include recording a crypto credit to fiat currency conversion on the distributed ledger. Methods may include recording, on the distributed ledger, time elapsed between distribution of crypto credits and conversion to a target fiat currency.

Methods may include receiving a change to how crypto credits are distributed among members of lending syndicate. A distribution of crypto credits may correspond to a level of monetary obligation to supply funds to a borrower. Methods may include validating the change by obtaining approval from a threshold number of members of the lending consortium. In some embodiments, the threshold number may be all members of the lending consortium.

Validating the change may include obtaining approval for the change from the borrower. Methods may include recording the change on the distributed ledger.

Methods may include determining an initial distribution of crypto credits to each member of the lending consortium. The initial distribution to a member of the lending consortium may be determined based on valuation of an asset owned the member. In response to receiving a threshold number of approvals for the valuation, methods may include recording the valuation on the distributed ledger. Approval for the valuation may be from other members of the lending consortium. Approval for the valuation may be provided by one or more third party oracles.

Methods may include recording, on the distributed ledger, a transfer of title to an asset from a member of the lending consortium to an agent address. In response to recording the transfer of tile on the distributed ledger, methods may include distributing crypto credits to the member of the lending consortium. The distribution may correspond to the valuation of the asset. The syndicated smart contract may be programmed to initiate the distribution of crypto credits in response to the agent address detecting recordation of the title transfer on the distributed ledger.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with another illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus and/or method embodiment.

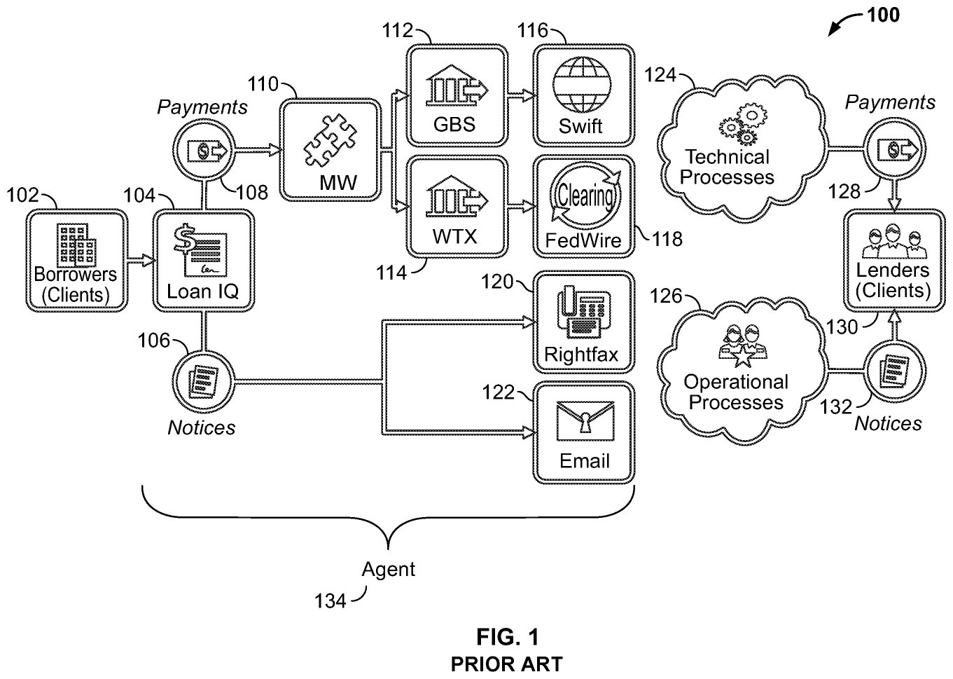

FIG. 1 shows illustrative prior-art syndicated loan servicing scenario 100. Scenario 100 shows illustrative interactions between borrower 102, agent 134 and lending members 130. Agent 134 may provide disbursements to borrower 102. Borrower 102 may make payments on the syndicated loan to agent 134. Agent 134 may act in a representative capacity on behalf of members 130 of a lending consortium.

Scenario 100 shows borrower 102 initiating payment 108 based on contract 104. Payment 108 is transmitted using middleware applications 110, to currency routing platforms 112 or 114. Currency routing platform 112 is used to route international payments. Currency routing platform 114 is used to route domestic payments. International payments may be carried via Swift network 116. Domestic payments may be carried via FedWire network 118.

Scenario 100 also shows that borrower 102 arranges separately for transmission of notices 106 and payments 108. Middleware applications (112 and 114) and currency routing platforms (116 and 118) are unable to carry notices 106. Accordingly, in prior art scenario 100, notices 106 must be prepared and transmitted using other non-payment carrying systems such as fax 120 or email 122.

After borrower 102 has prepared and transmitted payments 108 and notices 106, they are received at agent 134. Agent 134 distributes payments 108 pro rata among members 130 of a lending consortium. Agent 134 also prepares and transmits appropriate notices 132 of distributions made to members 130 of the lending consortium.

Agent 134 and/or lending agents 130 may employ technical processes 124 and operational processes 126 to appropriately process incoming payments 108 and prepare distribution payments 128. Agent 134 and/or lending members 130 may employ technical processes 124 and operational processes 126 to prepare and receive appropriate notices 132. Notices 132 are transmitted to members 130. Notices 132 may provide detail on payment 108 and an explanation of distribution payment 128.

Processes shown in scenario 100 may be repeated until the syndicated loan matures. However, the systems and processes shown in scenario 100 suffer from significant technical drawbacks. For example, systems and processes shown in scenario 100 are relatively slow (e.g., taking days to settle), prone to error (e.g., notices and payments may not be properly reconciled or timely received) and costly (e.g., fees charged by middleware applications and payment networks).

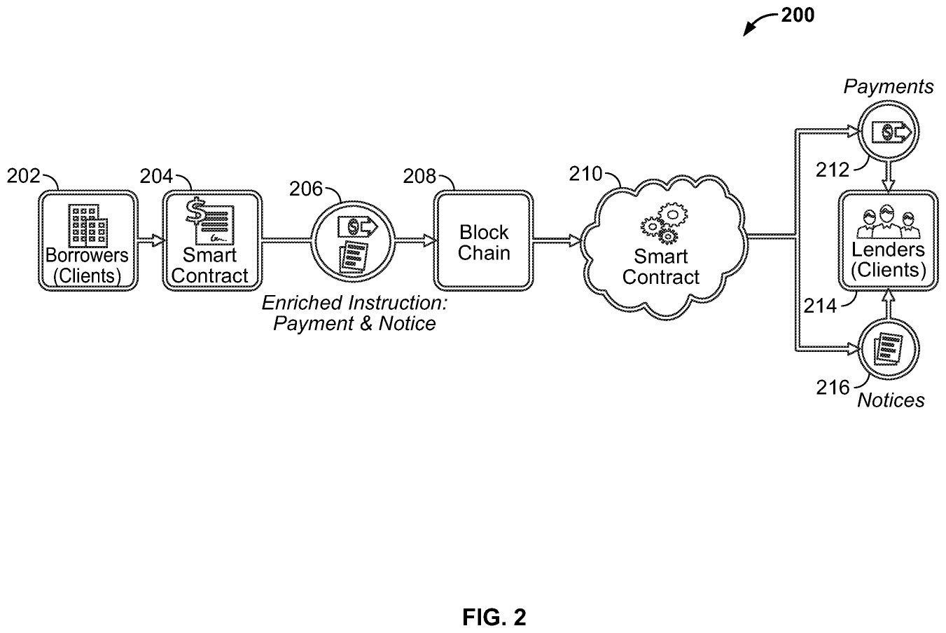

FIG. 2 shows illustrative syndicated loan servicing scenario 200. Scenario 200 may overcome technical shortfalls of prior-art loan servicing scenario 100.

Scenario 200 shows borrower 202 may provide inputs directly to smart contract 204. Inputs may include borrower payments. Inputs may include notices.

Smart contract 204 may bundle borrower payments and associated notices into transaction 206. Transaction 206 may be validated and recorded in a distributed ledger, such as blockchain 208. After transaction 206 is recorded on blockchain 208, there is no need to transmit confirmation to borrower 208. There is also no need to transmit notification to an agent. For example, transaction 206 may include a payment to an agent address or e-wallet. Upon recordation of transaction 206 in blockchain 208, the payment and notice associated with transaction 206 are available to an agent or directly to lending members 214.

Smart contract 210 may detect transaction 206 has been recorded on blockchain 208. When smart contract 210 detects that transaction 206 has been recorded on blockchain 208, smart contract 210 may prepare distribution payments 212 and associated notices 216 for each lending member 214 of a lending consortium. Smart contract 210 may prepare distribution payments 212 and notices 216 based on criteria pre-programmed into smart contract 210. Payments 212 and notices 216 may also be recorded on blockchain 208.

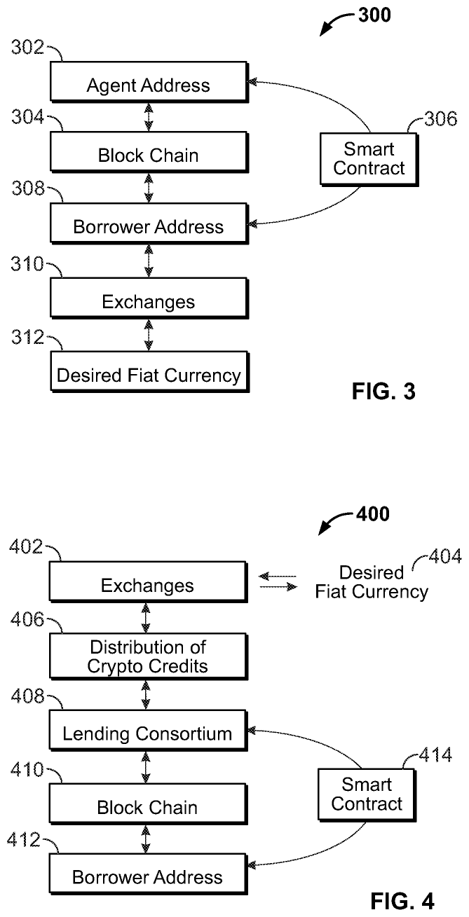

FIG. 3 shows illustrative syndicated loan servicing scenario 300. Scenario 300 includes agent address 302. Agent address 302 may correspond to an e-wallet of an agent administering a syndicated loan. Smart contract 306 may control transactions that transfer crypto credits and if needed, associated settlement into desired fiat currencies.

Smart contract 306 may control transactions between agent address 302 and borrower address 308. Borrower address 308 may correspond to an e-wallet of an agent administering a syndicated loan. Smart contract 306 may control transactions that transfer funds from borrower address 308 to agent address 306. Transactions initiated by smart contract 306 may be recorded in a distributed ledger, such as blockchain 304.

Blockchain 304 may create and maintain a shared source of truth for transaction details associated with a syndicated loan. As transactions occur over the lifetime of a syndicated loan, a corresponding record of each transaction is anchored to smart contract 306, creating a chronological audit trail of all activity associated with the syndicated loan.

Transactions between agent address 302 and borrower address 308 may be in terms of crypto credits. Crypto credits may include any suitable cryptocurrency or crypto tokens. Exemplary cryptocurrencies may include Bitcoin, Ethereum, Ripple, Bitcoin Cash, NEM, Litecoin, IOTA, NEO, Dash, Qtum, Monero and/or Dogecoin.

Scenario 300 may include converting crypto credits into fiat currency. For example, scenario 300 shows that crypto credits may be transferred from borrower address 308 to exchange 310. Exchange 310 may accept crypto credits and convert the crypto credits to desired fiat currency 312. Converting crypto credits to desired fiat currency 312 may settle a transaction between borrower and agent.

Exchanges to fiat currency 312 may be controlled by smart contract 306. For example, smart contract 306 may require that a transfer of crypto credits from agent address 302 to borrower address 308 be converted into desired fiat currency 312 within a predetermined timeframe.

Smart contract 306 may be configured to implement a conversion of crypto credits into desired fiat currency using traditional currency transfer mechanisms such as FedWire or SWIFT to move currency between parties. Smart contract 306 may be configured to implement a conversion of crypto credits into desired fiat currency using a decentralized currency exchange.

FIG. 4 shows illustrative syndicated loan servicing scenario 400. Scenario 400 shows an illustrative loan payment from borrower address 412 to lending consortium 408. Scenario 400 shows that utilizing smart contracts running on a distributed ledger may eliminate a need for an intermediary agent to service a syndicated loan.

The payment from borrower address 412 to loan consortium 408 may be recorded as a transaction in a distributed ledger, such as blockchain 410. In response to detecting recordation of the payment transaction, smart contract 414 may trigger a distribution of crypto credits 406 to one or more members of lending consortium 408.

Scenario 400 shows that smart contract 414 may also control conversion and/or settlement of distributed crypto credits 406 into desired fiat currency 404 via exchange 402.

Exchanges to fiat currency 404 may be controlled by smart contract 414. For example, smart contract 414 may require that distribution of crypto credits 406 be converted into desired fiat currency 404 within a predetermined timeframe.

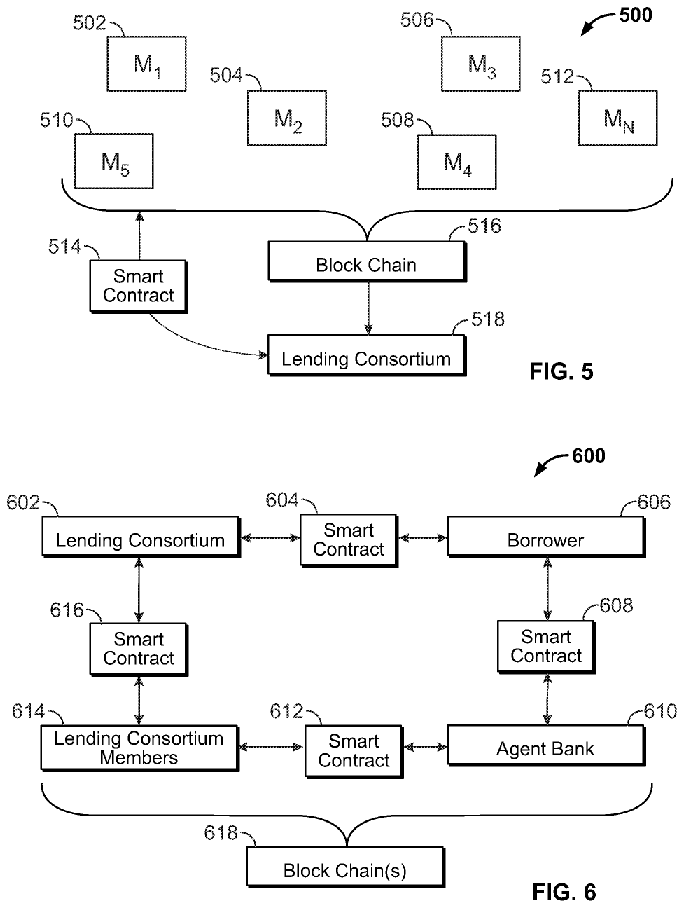

FIG. 5 shows illustrative scenario 500. In scenario 500, smart contract 514 controls transactions and interactions among members of lending consortium 518. A lending consortium may include any suitable number of members. Scenario 500 shows that lending consortium 518 includes members 502, 504, 506, 508, 510 and 512.

Members of lending consortium 518 may pool their financial resources to provide the syndicated loan to a borrower. Each member of lending consortium 418 may contribute different financial resources to the pool. For example, a member may contribute real estate, cash, precious stones, precious metals, option contracts, government bonds, or any other suitable asset that has verifiable value. A member's contribution of financial resources may be converted into crypto credits by smart contract 514.

For example, smart contract 514 may obtain an agreed upon value of a financial resource by polling members of lending consortium 518. Smart contract 514 may conduct the poll using any suitable consensus protocol. The consensus protocol may be associated with recording a transaction in a distributed ledger, such as blockchain 516. Smart contract 514 may obtain an agreed upon value of a financial resource from a third party oracle. The third party oracle may be coded into smart contract 514. Valuations of financial resources may be recorded in blockchain 516.

Smart contract 514 may distribute crypto credits to members of lending consortium 518. The distribution of crypto credits to a member may be based on a value of financial resources contributed by the member. Distributions of crypto credits among members of lending consortium may be recorded in blockchain 516.

Smart contract 514 may control disbursements from lending consortium 518 to a borrower. Smart contract 514 may control settlement of disbursements to the borrower. Disbursements may include a transfer of crypto credits. Disbursements may include a transfer of fiat currency. Disbursements may include a conversion of crypto credits into fiat currency.

Based on a transfer of crypto credits, smart contract 514 may initiate a transfer of fiat currency between parties. Smart contract 514 may control a transfer fiat currency directly from a member of lending consortium 408 to a borrower. Transfers of fiat currency between parties may settle a transaction between the parties.

Disbursements may be recorded in blockchain 516. Smart contract 514 may control receipt of payments from a borrower to lending consortium 518. Payments may be recorded in blockchain 516. Smart contract 514 may control distributions of loan proceeds to members of lending consortium 518. Distributions may include a transfer of crypto credits. Distributions may include a transfer of fiat currency. Distributions may include a conversion of crypto credits into fiat currency. Distributions may be recorded in blockchain 516.

Smart contract 514 may control membership in lending consortium 518. If a member wishes to exit lending consortium 518, smart contract 514 may control ownership of financial resources contributed by the exiting member. If a new member wishes to join lending consortium 518, smart contract 514 may control ownership of financial resources contributed by the new member. Smart contract 514 may also be configured to obtain borrower approval before allowing a change to membership in lending consortium 518.

Smart contract 514 may also control changes to ownership interests in a syndicated loan held by members of lending consortium 518. For example, a first member may wish to reduce their financial obligation to contribute funds to a syndicated loan. A second member may wish to assume the obligations, and associated proceeds, of the first member. Smart contract 514 may re-distribute crypto credits to reflect a change in ownership and corresponding financial obligations. Changes to the financial obligations and any associated re-distributions of crypto credits may be recorded in blockchain 516.

In some embodiments, exchanges of ownership interests between existing members of a lending consortium may not need borrower approval.

To settle a change in ownership, smart contract 514 may initiate a transfer of fiat currency between members or other parties to the syndicated loan. Settling a transaction between two parties may include a transfer of crypto credits and/or fiat currency to a third party. Smart contact 514 may control such settlement and associated transfers.

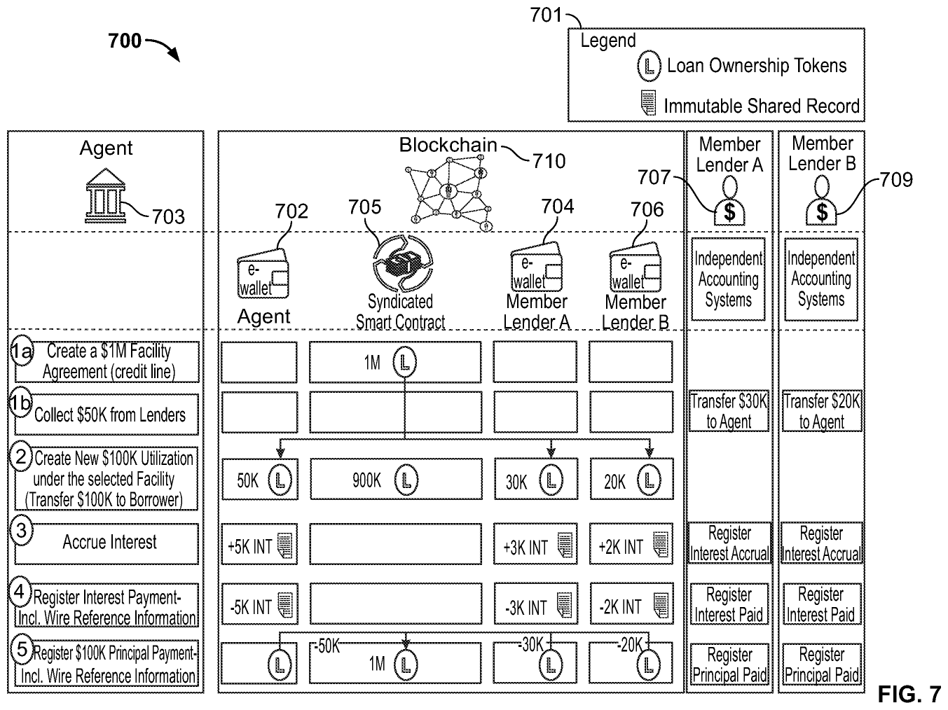

FIG. 6 shows illustrative scenario 600. In scenario 600, smart contract 604 controls transactions and interactions between lending consortium 602 and borrower 606. Illustrative transactions between borrower 606 and lending consortium 602 include changes to membership or, ownership interests, in lending consortium 602.

In scenario 600, smart contract 608 controls transactions and interactions between borrower 606 and agent 610. Transactions between borrower 606 and agent 610 may include transfers of crypto credits and/or fiat currencies. For example, settling a transaction between borrower 606 and agent 610 may include a transfer of crypto credits and/or fiat currency to borrower 606, agent 610 or a third party. Smart contact 608 may control such transfers and settlements. Illustrative transactions between borrower 606 and agent 610 include disbursements to borrower 606 and payments to agent 610.

In scenario 600, smart contract 612 controls transactions and interactions between agent 610 and lending consortium members 614. Illustrative transactions between agent 610 and lending consortium members 614 may include distribution of proceeds of a syndicated loan from agent 610 to lending consortium members 614.

Distributions of proceeds may include transfers of crypto credits and/or fiat currencies. For example, settling a distribution between agent 610 and a lending consortium member 614 may include a transfer of crypto credits and/or fiat currency to borrower 606, agent 610, another lending consortium member or a third party. Smart contact 612 may control such transfers and settlements.

In scenario 600, smart contract 616 controls transactions and interactions between lending consortium 616 and lending consortium members 614. Illustrative transactions between lending consortium 616 and lending consortium members 614 may include valuations of assets and title transfers of those assets. Illustrative transactions between lending consortium 616 and lending consortium members 614 may include distributions of crypto credits that corresponds to a member's pro rata share of the obligations and/or proceeds associated with a syndicated loan.

To settle a change in ownership, smart contract 616 may initiate a transfer of fiat currency between two or more lending consortium members 614 or other parties (e.g., borrower 606, agent 610) to the syndicated loan. Settling a transaction between two parties may include a transfer of crypto credits and/or fiat currency to a third party. Smart contact 616 may control such transfers and settlements.

Each transaction triggered or effected by any of smart contracts 604, 608, 612 or 616 may be recorded in a distributed ledger, such as blockchain 618. One or more of the smart contracts shown in scenario 600 may utilize an output of another smart contract (e.g., recorded on blockchain 618) as a trigger event to initiate a transaction.

Utilizing multiple smart contracts to control specific interactions between specific parties may increase stability of pass-through processing of a syndicated loan. Each smart contract may be configured to control specific interactions and may be vigorously tested to ensure it is bug-free. Such a stable operating environment may reduce susceptibility of a smart contract to malicious computer code or cyberattacks.

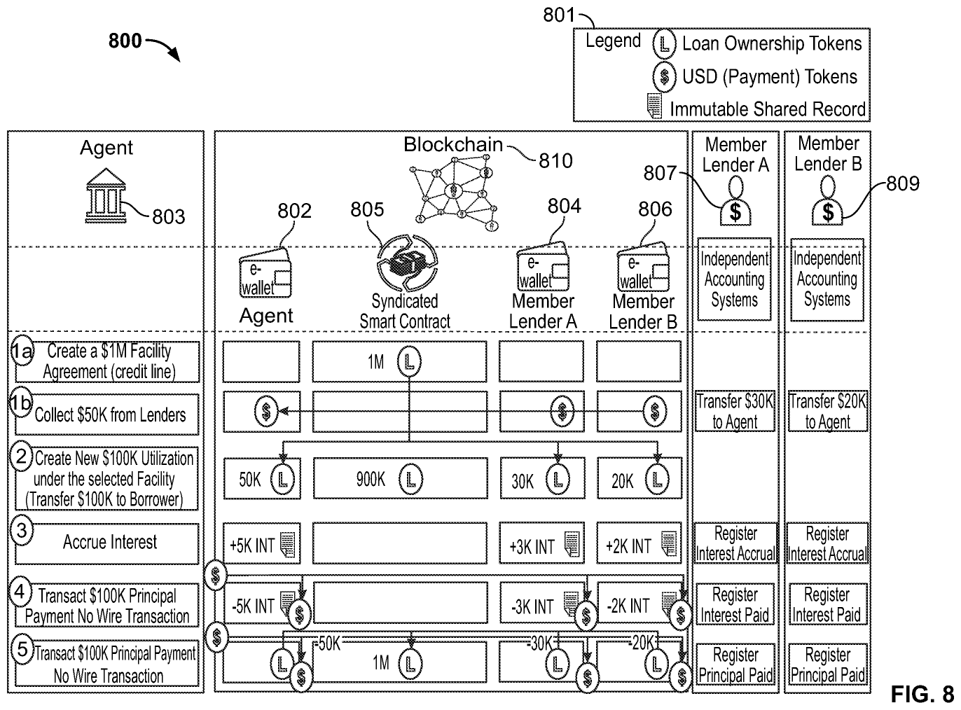

FIG. 7 shows illustrative process 700. For the sake of illustration, one or more of the steps of the process illustrated in FIG. 7 may be described as being performed by a “system.” The “system” may include one or more of the features of apparatus (software and/or hardware) or processes described herein and/or any other suitable device or approach.

Process 700 begins at step 1a. At step 1a, agent 703 creates a $1M facility agreement. The facility agreement may govern interactions between an agent, borrower and lending consortium with respect to a syndicated loan. The facility agreement may be codified in syndicated smart contract 705. Syndicated smart contract 705 may run on a distributed ledger, such as blockchain 710. Process 700 shows that at step 1a, syndicated smart contract 705 is ready to govern the $1M facility agreement. Step 1a shows that syndicated contract 705 is associated with crypto credits that represent $1M. Syndicated contract 705 may be configured to control distribution of the crypto credits.

At step 1b, agent 703 collects $30k from lending member 707. At step 1b, agent 703 also collects $20k from lending member 709. Agent 703 may itself be a member of the lending consortium and contribute $50k, to obtain a total disbursement amount of $100k. Syndicated smart contract 705 may orchestrate collection of funds from lending member 707, lending member 709 and agent 703. Syndicated smart contract 705 may orchestrate collection of funds via any suitable methods described herein. For example, via transfer of fiat currency.

Step 2 shows that loan ownership crypto credits are distributed by syndicated smart contract 705. In FIG. 7, loan ownership crypto credits are represented by an “L” designation. Loan ownership may reflect capital contributions of agent 703, lending member 707 and lending member 709 to a syndicated loan. Step 2 also shows that $900k (out of $1M) of loan ownership crypto credits remain unused. The $900k of remaining loan ownership crypto credits may be held by smart contract 705.

At step 2, $100k of loan ownership crypto credits may be distributed among agent 703, lending member 707 and lending member 709. The distributed amount of loan ownership crypto credits may correspond to each party's ownership interest in the syndicated loan. Distributions of loan ownership crypto credits may be recorded on blockchain 710. Syndicated smart contract 705 may transfer loan ownership crypto credits to agent e-wallet 702, lending member e-wallet 704 and/or lending member e-wallet 706. An e-wallet may correspond to an address or other identifier of party. The address may be used to identify parties that participated in the transaction recorded on blockchain 710.

Each party's pro rata share of proceeds of a syndicated loan may be determined based on loan ownership crypto credits held by each party. Loan ownership crypto credits may be distributed by syndicated smart contract 705 based on assets contributed by each party. Loan ownership crypto credits may be distributed independently of fiat currency that represents disbursements, payments or proceeds of a syndicated loan.

At step 3, interest begins to accrue on the $100k disbursed to the borrower. Step 3 also shows that accrual of interest is recorded on blockchain 710. Step 3 also shows that recording a transaction, such as interest accrual, on blockchain 710, creates a record of the transaction that is accessible to the borrower, agent 705, lending member 707 and lending member 709, yet may not be altered by any one party. Syndicated smart contract 705 may transfer interest accrual to agent e-wallet 702, lending member e-wallet 704 and/or lending member e-wallet 706.

At step 4, agent 703 receives an interest payment from the borrower. Agent 703 may receive the interest payment via a transaction initiated by borrower. Syndicated smart contract 705 may distribute, pro rata, the proceeds of the interest payments among agent 705, lending member 707 and lending member 709. Syndicated smart contract 705 may distribute the proceeds by triggering a transaction that transfers crypto credits to agent e-wallet 702, lending member e-wallet 704 and lending member e-wallet 706. Syndicated smart contract 705 may distribute the proceeds by triggering a transaction that offsets accruals held in agent e-wallet 702, lending member e-wallet 704 and/or lending member e-wallet 706. Offsetting the interest accruals may reconcile settlement of transactions associated with distribution of the proceeds.

The crypto credits distributed by syndicated smart contact 705 in response to a borrower payment may be different from the loan ownership crypto credits. For example, even after syndicated smart contract 705 makes a distribution of loan proceeds to members of the lending consortium, each member of the lending consortium may hold the same amount of loan ownership crypt credits as before the distribution.

At step 5, the borrower makes a $100k payment to repay the principal borrowed. Syndicated smart contract 705 may distribute, pro rata, the proceeds of the principal payments among agent 705, lending member 707 and lending member 709. FIG. 7 shows that proceeds are distributed by re-distributing crypto credits representing loan ownership interests. In FIG. 7, in response to receiving the $100k payment, syndicated smart contract 705 collects all distributed loan ownership crypto credits.

Syndicated smart contract 705 may distribute the proceeds by triggering a transaction that redistributes fiat currency among e-wallet 702, lending member e-wallet 704 and lending member e-wallet 706. Distribution of proceeds may include settling distributions by converting of crypto credits into fiat currency and transfer of the fiat currency to agent 703, lending member 707 and/or lending member 709.

FIG. 8 shows illustrative process 800. For the sake of illustration, one or more of the steps of the process illustrated in FIG. 8 may be described as being performed by a “system.” The “system” may include one or more of the features of apparatus (software and/or hardware) or processes described herein and/or any other suitable device or approach.

Process 800 begins at step 1a. At step 1a, agent 803 creates a $1M facility agreement, or credit line. The facility agreement may govern interactions between an agent, borrower and lending consortium with respect to a syndicated loan. The facility agreement may be codified in syndicated smart contract 805 running on blockchain 810. Process 800 shows that at step 1a, syndicated smart contract 805 is ready to govern the $1M facility agreement. Process 800 shows that at step 1a, syndicated smart contract 805 holds $1M of crypto credits for distribution.

Step 1b shows that agent 803 collects $30k from lending member 807. At step 1b, agent 803 also collects $20k from lending member 809. Agent 803 may itself be a member of the lending consortium and contribute $50k, to achieve a total available disbursement amount of $100k.

Step 1b shows that members of the lending consortium may contribute assets to a syndicated loan by adding crypto credits corresponding to a specific fiat currency amount, in this case, US Dollars (“USD”). In FIG. 8, such crypto credits are represented by a “$” designation. Step 1b shows that agent e-wallet 802 has been loaded with crypto credits corresponding to $50k USD of crypto credits collected from lending member 807 and lending member 809. The e-wallet may identify transaction conducted by the party on blockchain 810. An e-wallet may correspond to an address or other identifier of party.

Step 2 shows that syndicated smart contract 805 may distribute loan ownership crypto credits that reflect financial contributions of agent 803, lending member 807 and lending member 809. Step 2 also shows that $900k (out of $1M) of the syndicated loan remains unused by a borrower (not shown). At step 2, the $100k may be disbursed by agent 803 to the borrower. The distributions of crypto credits and disbursements to the borrower may be recorded on blockchain 810.

A desired destination of the borrower may include a demand deposit account at a financial institution. Syndicated smart contract 805 may control a disbursement to the borrower such that the borrower receives a deposit, in a demand deposit account, of a desired fiat currency amount. Payment details associated with a transfer of desired fiat currency to a demand deposit account may be recorded on blockchain 810. Specific details associated with a demand deposit account (e.g., account or routing number) may be encrypted before recording on blockchain 810.

Crypto credits held in an e-wallet may be converted into a desired fiat currency (in this case USD) by syndicated smart contract 805. For example, syndicated smart contract 805 may initiate a transfer of crypto credits from an e-wallet that exchanges the crypto credits for USD and deposits the USD into an e-wallet or other desired destination of the borrower. A desired destination of the borrower may include a demand deposit account at a financial institution.

Syndicated smart contract 805 may retain distributions of crypto credits among members of a lending consortium in crypto credit form. Syndicated smart contract 805 may convert disbursements and payments received from the borrower into any desired fiat currency.

At step 3, interest begins to accrue on the $100k disbursed to the borrower. Step 3 also shows that accrual of interest is recorded on blockchain 810. Step 3 also shows that recording a transaction, such as interest accrual on blockchain 810, creates a record of the transaction that is accessible to agent 805, lending member 807 and lending member 809, yet may not be altered by any one party. Transactions recorded on blockchain 810 may also be accessible to the borrower and unalterable by the borrower.

Syndicated smart contract 805 may record the accrual of interest in agent e-wallet 802, lending member e-wallet 804 and lending member e-wallet 806.

At step 4, agent 803 receives an interest payment from the borrower. Agent 803 may receive the interest payment via a transaction initiated by borrower. The borrower may transfer crypto credits. Transferred crypto credits may be converted into a desired fiat currency. The borrower may transfer a desired fiat currency.

Syndicated smart contract 805 may distribute, pro rata, the proceeds of the interest payment among agent 805, lending member 807 and lending member 809. Syndicated smart contract 805 may distribute the proceeds by triggering a transaction that transfers crypto credits (and/or conversion of crypto credits to fiat currency) to agent e-wallet 802, lending member e-wallet 804 and lending member e-wallet 806. Syndicated smart contract 805 may settle distributions of proceeds by transferring fiat currency to a direct deposit account.

At step 4, syndicated smart contract 805 may also distribute the proceeds by triggering a transaction that offsets interest accruals held in agent e-wallet 702, lending member e-wallet 704 and/or lending member e-wallet 706. Offsetting the interest accruals may reconcile settlement of transactions associated with distribution of the proceeds.

At step 5, the borrower may make a $100k payment to repay the principal borrowed. The borrower may transfer crypto credits and no wire transfer fees may be incurred. Crypto credits may be converted into a desired fiat currency. The borrower may transfer desired fiat currency directly. Syndicated smart contract 805 may distribute, pro rata, the proceeds of the principal payments among agent 805, lending member 807 and lending member 809. Syndicated smart contract 805 may settle distributions of proceeds by transfers of fiat currency to a direct deposit account or to an e-wallet destination.

Each party's pro rata share of the proceeds may be determined based on loan ownership crypto credits held by each party. Loan ownership crypto credits may be distributed by syndicated smart contract 805 based on assets contributed by each party. Loan ownership crypto credits may be distributed independently of crypto credits that represent disbursements, payments or proceeds of a syndicated loan.

Syndicated smart contract 805 may distribute the proceeds by triggering a transaction that redistributes crypto credits (and/or conversion of crypto credits to fiat currency) among e-wallet 802, lending member e-wallet 804 and lending member e-wallet 806. In FIG. 8, in response to receiving the $100k payment, syndicated smart contract 805 collects all distributed loan ownership crypto credits.

Thus, apparatus and methods for a SYNDICATED LOAN DISTRIBUTED LEDGER PASS-THROUGH PROCESSING have been provided. Persons skilled in the art will appreciate that the present disclosure can be practiced by other than the described embodiments, which are presented for purposes of illustration rather than of limitation. The present disclosure is limited only by the claims that follow.

What is claimed is:

1. A system for pass-through processing of a syndicated loan, the system comprising:
a computer system running a distributed electronic ledger;
a lender smart contract running on the computer system and configured to control interaction among members of a lending consortium; and
a borrower smart contract running on the computer system and configured to control interaction among the borrower and the lending consortium;
wherein:
the borrower smart contract is configured to:
receive a borrower payment on the syndicated loan;
validate the borrower payment; and
record the borrower payment on the distributed ledger;
the lender smart contract is configured to:
receive confirmation that the borrower payment has been validated and recorded in the distributed ledger; and
based on the borrower payment, distribute crypto credits among the members of the lending consortium.

2. The system of claim 1, wherein the borrower smart contract is configured to record the borrower payment on the distributed ledger by:
validating a transfer of crypto credits from the borrower to the lending consortium;
generating loan payment notice data based on the transfer;
recording the transfer and the loan payment notice as part of a single transaction in the distributed ledger.

3. The system of claim 2, wherein, in response to receiving the confirmation, the lender smart contract is further configured to:
calculate a lender payment for each member of the lending consortium;
generate a lender notice for each member of the lending consortium;
determine a distribution of crypto credits for each member of the lending consortium based on the lender payment;
wherein:
the lender notice and the lender payment comprise a lender-member transaction; and
the lender smart contract is configured to record each lender-member transaction as a single transaction in the distributed ledger.

4. The system of claim 3, wherein the lender smart contract is configured to:
receive a first request from a first member of the lending consortium to reduce their proportional obligation to supply funds to the borrower;
validate the first request;
record the first request in the distributed ledger;
circulate a second request for a second member of the lending consortium to increase their proportional obligation to supply funds to the borrower; and
in response to receiving a response from the second member of the lending consortium:
validate the response; and
record the response in the distributed ledger.

5. The system of claim 4 wherein, in response to detecting recordation the response of the second member in the distributed ledger, the borrower smart contract is configured to record a transaction between the lending consortium and the borrower recording the revised obligations of the first and second members of the lending consortium.

6. The system of claim 4, wherein the lender smart contract is configured to obtain the approval from the borrower smart contract before recording the response distributed ledger.

7. The system of claim 4, wherein the lender smart contract is configured to obtain the approval of the borrower smart contract before validating the first and the second requests.

8. The system of claim 6, wherein the borrower smart contract is configured to obtain approval from the lender smart contract before recording the transaction that adjusts the proportional obligations in the distributed ledger.

9. The system of claim 1, wherein:
the lender smart contract is configured to utilize:
a first public cryptographic key to validate transactions executed by members of the lending consortium; and
the borrower smart contract is configured to utilize:
a second public cryptographic key to validate transactions executed by the lending consortium; and
a third public cryptographic key to validate transactions executed by members of the lending consortium.

10. A system for pass-through processing of a syndicated loan, the system comprising:
a syndicated smart contract running on a distributed ledger, the syndicated smart contract configured to control crypto credit transfers:
between an agent address and a borrower address; and
between the agent address and a plurality of lending member addresses;
a crypto credit exchange configured to receive and execute transfer instructions generated by the syndicated smart contract;
wherein, the syndicated smart contract is configured to:
initiate and validate crypto credit transfer requests received from the agent address;
receive and validate crypto credit transfer requests received from the borrower address;
issue executable instructions to the crypto credit exchange that transfer crypto credits between the agent address and the borrower address; and
issue executable instructions to the crypto credit exchange that transfer crypto credits between the agent address and one or more of the plurality of lending member addresses.

11. The system of claim 10, wherein the syndicated smart contract is configured to generate executable instructions that:
transfer crypto credits from the agent address to the borrower address;
convert the crypto credits into a fiat currency;
based on the transfer and conversion, generate borrower notice data; and
record the executable instructions in the distributed ledger.

12. The system of claim 10, wherein the syndicated smart contract is further configured to:
formulate an adjustment transaction that transfers crypto credits from one of the plurality of lending member addresses to a new lending member address;
submits the adjustment transaction to the borrower address for approval;
in response to receiving the approval from the borrower address:
issue executable instructions to the crypto exchange that transfers crypto credits from the one of the plurality of lending member addresses to the new lending member address;
add the new lending member address to the plurality of lending member addresses; and
record the adjustment transaction in the distributed ledger.

13. The system of claim 10, wherein the syndicated smart contract is configured to:
receive a disbursement request from the borrower address for a desired amount of fiat currency;
determine a proportional amount of crypto credits required from each lending member address; and
submit, to the crypto exchange, executable instructions that transfer:
the proportional amounts from each lending member address to the agent address; and
the desired amount of fiat currency to the borrower address.

14. The system of claim 14, wherein:
each transfer of crypto credits is recorded in the distributed ledger along with first notice data; and
each conversion of crypto credits to fiat currency is recorded in the distributed ledger along with second notice data.

15. The system of claim 10, wherein the syndicated smart contract is configured to determine an amount of crypto credits issued to each lending member in response to title of an asset being transferred to the agent address.

16. The system of claim 10, wherein the syndicated smart contract is configured to require approval from the borrower address to execute a transfer of crypto credits from a first of the plurality of lending member addresses to a second of the plurality of lending member addresses.

17. A method for pass-through processing of a syndicated loan, the method comprising:
recording the syndicated loan in a distributed electronic ledger;
receiving a payment transaction from a borrower;
validating the payment transaction using a consensus algorithm of the distributed electronic ledger;
recording the payment transaction in the distributed electronic ledger;
in response to recording the payment transaction, validating a distribution of crypto credits to members of a lending consortium; and
recording the distribution in the distributed electronic ledger.

18. The method of claim 17 further comprising:
converting the distributed crypto credits into a fiat currency; and
recording the converting on the distributed electronic ledger.

19. The method of claim 17 further comprising:
receiving a change to the members of the lending consortium;
validating the change by obtaining approval from:
a threshold number of members of the lending consortium; and
the borrower; and
recording the change on the distributed electronic ledger.

20. The method of claim 19, wherein the change comprises adding a new member to the lending consortium, the method further comprising:
circulating a valuation of an asset owned by the new member to the members of the lending consortium;
in response to receiving a threshold number of approvals for the valuation, recording the valuation on the distributed electronic ledger;
recording, on the distributed electronic ledger a transfer of title to the asset from the new member of the lending consortium to an agent address; and
in response to recording the transfer of tile, transferring an amount of crypto credits to the new member, the amount corresponding the valuation of the asset.
